(19) United States
(12) Patent Application Publication
(10) Pub. No.: US 2025/0341655 A1
(43) Pub. Date: Nov. 6, 2025

(54) LiDAR REFLECTIVE COATINGS

(71) Applicant: BASF COATINGS GMBH, Muenster (DE)

(72) Inventors: Michaela LIESE, Muenster (DE); Bastian SCHAEFER, Muenster (DE); Markus MUNDUS, Muenster (DE); Alfred WOLCKE, Muenster (DE)

(21) Appl. No.: 19/126,411

(22) PCT Filed: Nov. 14, 2023
(86) PCT No.: PCT/EP23/81768

§ 371 Date: May 1, 2025

(30) Foreign Application Priority Data
Nov. 15, 2022 (EP) 22207558.2

(51) Int. Cl. G02B 1/12; G01S 17/931; G02B 1/02

(52) U.S. Cl. CPC G02B 1/12; G01S 17/931; G02B 1/02

(57) ABSTRACT

Disclosed herein is a basecoat composition, including (A) at least one film-forming polymer (A1), and in case of (A1) being externally crosslinkable, at least one crosslinking agent (A2); (B) at least two types of metal effect pigments (B); (C) at least one type of a LiDAR reflecting mica pigment (C); and (D) water and/or one or more organic solvents as component (D). Further disclosed herein are a method of forming a coating layer or multilayer coating as well as a method of improving the LiDAR reflectivity and/or LiDAR detectability of objects. Additionally disclosed herein are coating layers and coated substrates, the formation of which make use of the basecoat compositions. Also disclosed herein is a method of using the coated substrates in LiDAR visibility applications concerning vehicles and parts thereof.

The present invention relates to light silver-colored basecoat compositions comprising metal effect pigments, mica pigments and optionally near infrared-reflective and/or near-infrared transparent color pigment blends. The invention further relates to a method of forming a coating film making use of the basecoat composition, the thus obtained coating film and an at least partially coated substrate as well as the use of the coatings in LiDAR applications.

### BACKGROUND OF THE INVENTION

Recent advances have been made in technologies related to self-driving vehicles and vehicles with ADAS (Advanced Driver Assistance Systems). Vehicles with ADAS decrease driving stress, decrease the number of accidents, improve fuel economy etc.

Typically, such technologies require the detection of objects in a vehicle's surroundings. Detecting systems generally comprise sensors, cameras, radar, ultrasonic, and lasers to detect and locate obstacles such that the vehicle can safely navigate around such objects. Some detecting systems are limited in their ability to detect objects at long distances or non-ideal environments, such as in low-light conditions, in inclement weather, such as fog, rain, and snow, or in other conditions with light scattering particulates in the air (e.g., smog and dust). Such limitations may prohibit the vehicles from safely navigating obstacles.

ADAS rely highly rely on remote sensing technologies on optical or electromagnetic means for position and speed determination.

LiDAR (Light Detection And Ranging) is a remote-sensing technology that can be deployed within such vehicles as the primary source of object recognition. By illuminating the surrounding environment with Laser light (typically 905 nm or 1550 nm) LiDAR maps distance to objects in its path in real-time and can be paired with software to safely react to objects within their vicinity. For example, if an object gets too close to the vehicle, the software can react to avoid collision with the object. Since LiDAR utilizes near-infrared light (near-IR light or NIR light) as its source of illumination, the technology must overcome several challenges.

Although many light-colored objects reflect this type of light well over a broad range of incidence angles, silver colored coating, particularly coatings containing aluminum flake pigments need to be improved at higher incidence angles.

This shows that apart from the LiDAR instrument, one of the important factors for the accuracy of the measurement is the surface of the illuminated object. In case of the automobiles and other vehicles, the surface is usually covered by a multilayer coating, which plays an important role in determining the LiDAR reflectivity.

An object's ability to reflect light is dependent on its bulk and surface properties, and manifests itself as specular or diffuse. Specular reflection of light occurs when incident light stemming from a light source in a single direction is reflected into a single outgoing direction at the opposite angle to the plane normal to the reflective surface as the incident wave. Diffuse reflection occurs when incident light stemming from a light source in a single direction is reflected at many angles. In theory, both specular and diffuse reflection can be utilized in LiDAR technology for vehicles, but in practice, this is much more difficult. With specular reflection, much of the luminance is observed at the angle opposite the angle of incidence. Thus, for a moving vehicle with a detector positioned at the light source, this could prove problematic if the angle of incidence was positioned away from the tandem light source and detector. While typically at low incident angles of, e.g., 0° to 10°, LiDAR reflectivity is at its maximum, LiDAR reflectivity significantly drops at higher incident angles, such as an incident angle of 15° or higher from the plane normal to the reflective surface. Thus, it was an aim of the present invention to significantly improve the LiDAR reflectivity at incident angles of 15° and higher, particularly in the range from about 15° to about 40° which is crucial an many automotive applications.

Still, most of the current coatings are applied to substrates such as vehicle bodies for improved durability and aesthetics, but usually impart no sufficient functionality in reflecting near-IR light for the purposes of greater visibility to LiDAR technology.

In recent years a few approaches were developed to improve the LiDAR reflectivity of multilayer coatings, particularly those applied to vehicles. To understand the approaches, one needs to consider the typical architecture of automotive multilayer coatings. The coating layers on vehicle bodies and parts thereof, starting from the substrate are typically a conversion coating layer, an electrodeposition coating layer, such as preferably a cathodic electrodeposition layer, a primer layer (also called filler layer), a basecoat layer, and on top of the basecoat layer a clearcoat layer as top coat. The afore-mentioned primer layer, basecoat layer and clearcoat layer are often referred to as tricoat.

In a first approach, NIR-reflective pigments are contained in the basecoat layer. The NIR light passes the non-NIR-absorbing protective clearcoat layer and is reflected by the NIR-reflective pigment(s) in the basecoat layers. In a different, second approach, the NIR light passes the non-NIR-absorbing protective clearcoat layer and the basecoat layer which may contain non-NIR-absorbing coloring pigments, but is reflected by the subjacent primer layer or substrate, if no primer layer is present.

While both approaches work well for solid color multilayer coatings, problems arise when metal effect pigments are contained in the basecoat layer to provide the multilayer coating with so-called lightness flop effect, particularly, if the lightness flop is to be provided in form of a silver-metallic multilayer coating. The term “lightness flop” (or just flop as used herein) refers to the difference between the amount or hue of light reflected at different angles from a metallic coating surface. The flop depends on particle size and distribution, particle shape and orientation of the effect pigment particles in the coating layer. The extend of the flop effect can be expressed by the so-called flop index, which is a measure of change in reflectance of a metallic coating containing platelet-shaped pigments as it is rotated through the range of viewing angles. A flop index of 0 indicates a solid color, while a very high flop may even result in a flop index of above 15.

Generally, the larger platelet-shaped particles are better reflectors leading to higher flop index and brightness, while smaller particles show less flop as the amount of light scattered at edges increases as a nondirectional reflection. With even coarser metallic pigments, the individual particles become more visible, leading to graininess or texture.

Thus, although the most desired platelet-shaped metallic pigments are typically highly reflective and coatings obtained by using such pigments typically possess a high flop index, they also possess a very specular reflectivity and therefore have low reflectivity in the off-specular angle range, which adversely affects the LiDAR reflectivity from those vehicles which are not directly in front of the light source/detector system, but at an angle or in adjacent lane thereto.

Consequently, coatings obtained by use of conventional metallic pigment containing coating compositions show a rather high flop index of 9 and above, while their LiDAR reflectivity at an angle of incidence of 45° is often even below 5%. Generally, the higher the flop the lower the LiDAR reflectivity.

Therefore, the present invention aims preserve the lightness flop at a level being about the same as for conventional silver-metallic coatings, while improving the visibility of thus coated objects to LiDAR detection, particularly for light-colored coatings. This should be reached by providing a basecoat composition comprising platelet-shaped metallic pigments to achieve a high flop index of the therewith obtained coating and which should further contain ingredients which have no or only a small effect on the flop index, but which are apt to equip the coating layer formed from the coating composition with a significantly increased LiDAR reflection. Furthermore, the ingredients to be added to the conventional silver-metallic basecoat composition should have a rather low hiding power to allow an excellent appearance of the multilayer coating comprising such basecoat layer, such appearance including the color effect provided by the primer layer of such multilayer coating.

### SUMMARY

The above aim is achieved by providing a basecoat composition, comprising
(A) at least one film-forming polymer (A1), and in case of (A1) being externally crosslinkable, at least one crosslinking agent (A2);
(B) at least two types of metal effect pigments (B); and
(C) at least one type of a LiDAR reflecting mica pigment (C),
(D) water and/or one or more organic solvents as component (D).

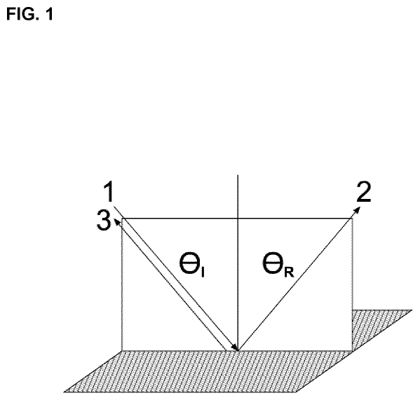

To facilitate the understanding of LiDAR reflection, angle of incidence and other terms used herein, it is referred to FIG. 1, wherein 1 and Θ_{I} stand for the transmitter and the angle of incidence, 2 and Θ_{R} stand for specular reflection and the reflection angle and 3 for the receiver (opposition angle).

Further object of the present invention is a method of forming a coating layer at least partially onto at least one surface of a substrate, wherein said method comprises at least step (a), namely
(a) applying the inventive basecoat composition according to the invention at least partially onto at least one surface of an optionally pre-coated substrate to form a coating layer on the surface of the substrate.

This method followed by
(b) curing the basecoat layer obtained after performing of step (a) to form a cured coating on the surface of the substrate,
   is also a suitable method of improving the LiDAR reflectivity and/or LiDAR detectability of objects, wherein the substrate is the object or becomes part of the object, which is to be improved in view of LiDAR reflectivity and/or LiDAR detectability.

Methods of forming multilayer coatings comprising the afore-mentioned method of forming a coating layer as well as methods of improving the LiDAR reflectivity and/or LiDAR detectability of objects making use of the method of forming the multilayer coatings are also object of the present invention.

Yet another object of the present invention is a coating layer obtainable from the coating composition according to the invention or by the method according to the present invention.

Further object of the invention is an at least partially coated substrate obtainable by the method according to the invention.

Another object of the invention is the use of the inventive coating composition in LiDAR visibility applications, in particular for autonomous systems such as self-driving vehicles and vehicles with ADAS.

### DETAILED DESCRIPTION

### Basecoat Composition

The inventive basecoat composition (herein also referred to as inventive coating composition), can be a solvent-based basecoat composition (in the following also referred to as solvent-borne basecoat composition) or an aqueous basecoat composition (in the following also referred to as waterborne basecoat composition). Preferably the coating composition is an aqueous basecoat composition. Preferably, the coating composition is used as a one-pack solvent-borne or waterborne basecoat composition. The inventive coating composition is in particular not a primer, primer surfacer or sealer composition and is thus not to be used/applied as a primer, primer surfacer or sealer composition. It typically forms the basecoat layer which is in direct contact with one or more clearcoat layers of a multilayer coating.

The coating composition according to the invention is suitable for producing a basecoat layer. The coating composition according to the invention is therefore particularly a solvent-borne basecoat composition or an aqueous basecoat composition.

The term “basecoat” is known in the art and, for example, defined in Römpp Lexikon, “Lacke und Druckfarben” (“Paints and “Printing Inks”), Georg Thieme Verlag, 1998, 10th edition, page 57. A basecoat is therefore in particular used in automotive coating and general industrial paint coloring in order to give a coloring and/or an optical effect by using the basecoat as an intermediate coating composition. Basecoat compositions are generally applied to a metal or plastic substrate, optionally pretreated and/or precoated with a primer and/or filler, sometimes in the case of plastic substrates it might also be applied directly on the plastic substrate, and in the case of metal substrates on an electrodeposition coating layer coated onto the metal substrate or on the metal substrate already bearing a primer and/or filler and/or electrodeposition coating, or to already existing coatings in case of refinish applications, which can also serve as substrates. In order to protect a basecoat layer in particular against environmental influences, at least one additional clearcoat layer is applied to it.

The term “comprising” in the general context of the present invention and particularly in connection with the coating composition according to the invention has the meaning of “containing” rather than “consisting of”. Particularly, “comprising” means that in addition to the components (A1), (A2), (B), (C) and (D) one or more of the other components mentioned hereinafter may optionally be contained in the coating composition according to the invention. All components can be present in each case in accordance with their preferred embodiments mentioned below.

The proportions and amounts in wt.-% (i.e., % by weight) of all components (A1), (A2), (B), (C) and (D) and further optionally present components in the coating composition according to the invention add up to 100 wt.-%, based on the total weight of the coating composition.

As used herein, the term “near-IR” or “near-infrared radiation or light” or “NIR” refers to electromagnetic radiation in the near-infrared range of the electromagnetic spectrum. Such near-IR electromagnetic radiation may have a wavelength from 800 nm to 2500 nm, such as from 850 to 2000 nm or such as from 900 nm to 1600 nm. In particular, the NIR light used has a wavelength from 880 nm to 930 nm with 905 nm as center wavelength. The near-IR electromagnetic radiation source that may be used in the present invention to produce NIR light includes, without limitation, light emitting diodes (LEDs), laser diodes or any light source that can emit electromagnetic radiation having a wavelength from 800 nm to 2500 nm (in the near-IR range). The near-IR electromagnetic radiation source may be used in a LiDAR (Light Detection and Ranging) system. The LiDAR system may utilize lasers to generate electromagnetic radiation with a wavelength from 900 nm to 1600 nm.

Preferably, the coating layer obtained from the coating composition of the present invention is able to reflect NIR light, preferably NIR light having a wavelength from 800 to 2500 nm.

Besides the pigments of components (B) and (C) the basecoat compositions of the present invention may contain one or more further pigments as component (E).

If further pigments (E) are contained, they should preferably be LiDAR reflecting or LiDAR transparent, i.e., preferably not LiDAR absorbing.

Preferably, the inventive coating composition does not contain any further components that are fillers. Thus, the inventive coating composition is preferably filler-free. In case any components are contained in the coating composition, that are pigments and/or fillers other than (B), (C) and (E), these components preferably do not or preferably do substantially not absorb light. Herein, thickeners, i.e., thickening agents are not considered to be subsumed under the term “pigments and/or fillers”.

Preferably, the solids content of the coating composition according to the invention is in a range from 10 to 35 wt.-%, more preferably from 15 to 30 wt.-%, even more preferably from 17 to 28 wt.-%, most preferably from 19 to 26 wt.-% in particular from 20 to 24 wt. %. The determination of the solids content, i.e., the non-volatile content, is carried out by drying a 1 g sample of the coating compositions at 125° C. for 60 min.

Details of this method are disclosed in the experimental section of the present invention.

### Film-Forming Polymer (A1)

The inventive coating composition comprises at least one film-forming polymer as film-forming binder (A1) of the coating composition.

For the purposes of the present invention, the term (A1) is understood to be the non-volatile constituent of a coating composition, which is responsible for the film formation, excluding additives, particularly excluding additives (E). Preferably, at least one polymer of the at least one polymer (A1) is the main binder of the coating composition. As the main binder in the present invention, a binder component is preferably referred to, when there is no other binder component in the coating composition, which is present in a higher proportion based on the total weight of the coating composition.

The term “polymer” is known to the person skilled in the art and, for the purposes of the present invention, encompasses polyadducts and polymerizates as well as polycondensates. The term “polymer” includes both homopolymers and copolymers.

The at least one polymer used as component (A1) may be physically drying, self-crosslinkable or externally crosslinkable. Suitable polymers which can be used as component (A1) are, for example, described in EP 0 228 003 A1, DE 44 38 504 A1, EP 0 593 454 B1, DE 199 48 004 A1, EP 0 787 159 B1, DE 40 09 858 A1, DE 44 37 535 A1, WO 92/15405 A1 and WO 2005/021168 A1.

The at least one polymer used as component (A1) is preferably selected from the group consisting of polyurethanes, polyureas, polyesters, polyamides, poly(meth)acrylates and/or copolymers of the structural units of said polymers, in particular polyurethane-poly(meth)acrylates and/or polyurethane polyureas. The at least one polymer used as component (A1) is particularly preferably selected from the group consisting of polyurethanes, polyesters, poly(meth)acrylates and/or copolymers of the structural units of said polymers. The term “(meth) acryl” or “(meth) acrylate” in the context of the present invention in each case comprises the meanings “methacrylic” and/or “acrylic” or “methacrylate” and/or “acrylate”.

Preferred polyurethanes are described, for example, in German patent application DE 199 48 004 A1, page 4, line 19 to page 11, line 29 (polyurethane prepolymer B1), in European patent application EP 0 228 003 A1, page 3, line 24 to page 5, Line 40, European Patent Application EP 0 634 431 A1, page 3, line 38 to page 8, line 9, and international patent application WO 92/15405, page 2, line 35 to page 10, line 32.

Preferred polyesters are described, for example, in DE 4009858 A1 in column 6, line 53 to column 7, line 61 and column 10, line 24 to column 13, line 3 or WO 2014/033135 A2, page 2, line 24 to page 7, line 10 and page 28, line 13 to page 29, line 13 described. Likewise, polyesters may have a dendritic structure, as described, for example, in WO 2008/148555 A1.

Preferred polyurethane-poly(meth)acrylate copolymers (e.g., (meth)acrylated polyurethanes)) and their preparation are described, for example, in WO 91/15528 A1, page 3, line 21 to page 20, line 33 and in DE 4437535 A1, page 2, line 27 to page 6, line 22 described.

Preferred poly(meth) acrylates are those which can be prepared by multistage free-radical emulsion polymerization of olefinically unsaturated monomers in water and/or organic solvents. For example, seed-core-shell polymers (SCS polymers) are particularly preferred. Such polymers or aqueous dispersions containing such polymers are known, for example, from WO 2016/116299 A1.

Preferred polyurethane-polyurea copolymers are polyurethane-polyurea particles, preferably those having an average particle size of 40 to 2000 nm, the polyurethane-polyurea particles, each in reacted form, containing at least one isocyanate group-containing polyurethane prepolymer containing anionic and/or groups which can be converted into anionic groups and at least one polyamine containing two primary amino groups and one or two secondary amino groups. Preferably, such copolymers are used in the form of an aqueous dispersion. Such polymers can in principle be prepared by conventional polyaddition of, for example, polyisocyanates with polyols and polyamines.

The polymer used as component (A1) preferably has reactive functional groups which enable a crosslinking reaction. Any common crosslinkable reactive functional group known to those skilled in the art can be present. Preferably, the polymer used as component (A1) has at least one kind of functional reactive groups selected from the group consisting of primary amino groups, secondary amino groups, hydroxyl groups, thiol groups, carboxyl groups and carbamate groups. Preferably, the polymer used as component (A1) has hydroxy functional groups.

Preferably, the polymer used as component (A1) is hydroxy-functional and more preferably has an OH number in the range of 10 to 500 mg KOH/g, more preferably from 40 to 200 mg KOH/g.

The polymer used as component (A1) is particularly preferably a hydroxy-functional polyurethane-poly(meth)acrylate copolymer, a hydroxy-functional polyester and/or a hydroxy-functional polyurethane-polyurea copolymer.

In addition, the coating composition of the present invention may contain at least one typical crosslinking agent known per se. Crosslinking agents are to be included among the film-forming non-volatile components of a coating composition, and therefore fall within the general definition of the “binder”. Crosslinking agents are thus to be subsumed under the component (A).

### Crosslinking Agent (A2)

If (A1) is externally crosslinkable, a crosslinking agent (A2) is needed for crosslinking, which preferably is at least one aminoplast resin and/or at least one blocked or free, preferably blocked polyisocyanate, and most preferably an aminoplast resin. Most preferred, in case of aqueous one-pack basecoat compositions is the presence of aminoplast resins. Among the aminoplast resins, melamine resins such as melamine-formaldehyde resins are particularly preferred.

### Metal Effect Pigments (B)

The term “metal effect pigment” is used in accordance with EN ISO 18451-1:2019 (Pigments, dyestuffs and extenders—Terminology—Part 1). Metal effect pigments are defined as platelet-shaped pigments consisting of metal. In the present invention the term “consisting of metal” does not exclude surface modifications of the metal effect pigments such as the presence of additional oxide layers, as e.g., a silicon dioxide layer. The term “metal” as used in the term “metal effect pigments” includes metals and metal alloys, likewise. Metal effect pigments—as already lined out above—can be orientated in parallel and show metallic gloss due to light reflection at the flakes.

Typical metals and alloys used in metal effect pigments are aluminum, and its alloys. Most suitable and preferred in the present invention are platelet-shaped aluminum effect pigments, which might be coated or uncoated and which are preferably coated, particularly in case of the preferred aluminum pigments to inhibit their reaction with water in aqueous basecoat compositions. Such inhibition can e.g., be achieved using organo-phosphorous stabilization; passivating the aluminum pigments with a conversion layer, e.g., by chromating; encapsulation with a protective layer, such as a polymer coating or a silica coating (Peter Wißling, “Metallic Effect Pigments”, Vincentz Network 2006, pp. 85-89). Such aluminum effect pigments are e.g., commercially available from ECKART GmbH (Germany) under the tradenames STAPA® Hydroxal (stabilized), STAPA® Hydrolux (chromated) and STAPA® Hydrolan (silica encapsulated). Further modification of the pigment surfaces is also possible, e.g., by modification with non-polar groups, such as alkyl groups leading to a so-called semi-leafing effect.

The metal effect pigments, particularly aluminum effect pigments, may be coated with an oxide layer, such as a silica layer and/or a chromium (III) oxide layer, which further helps to stabilize the pigments against mechanical impact und particularly improves circulation line stability. In the present invention oxide encapsulated aluminum metal effect pigments are preferred. Preferably, the amount of the oxide layer, based on the sum of the amounts of aluminum and oxide layer in such preferred aluminum effect pigments ranges from 3 to 15 wt.-% more preferred from 5 to 12 wt.-% and most preferred from 6 to 10 wt.-%. However, the term “metal effect pigment” encompasses such coated pigments and the total weight of such coated metal effect pigment is understood to be the weight of the metal effect pigment. Thus, the weight includes the coating material.

In the present invention at least two types of metal effect pigments, preferably at least two types of aluminum effect pigments are employed in the basecoat compositions of the present invention.

As stated above, metal effect pigments are platelet-shaped as per definition. However, they may have different particle shapes and different particle size distributions and may be leafing or non-leafing metal effect pigments. In the present invention the at least two different metal effect pigments are preferably non-leafing pigments, more preferably non-leafing aluminum effect pigments having different shapes and/or different particle size distributions.

The shape of the pigment particles as employed in the present invention varies depending on the pigment manufacturing process. The shapes range from irregular formed platelets known as cornflake-shaped pigments to almost round platelets with minimal scattering proportions which are known as silver dollar-shaped pigments. Pictures and typical characteristics of both, cornflake-shaped and silver dollar shaped pigments are, e.g., shown in the textbook of Peter Wißling, “Metallic Effect Pigments”, Vincentz Network 2006, pp. 31-33. It is preferred in the present invention that at least one type of metal effect pigment employed in the basecoat composition of the present invention is a cornflake-shaped metal effect pigment, preferably a cornflake-shaped aluminum effect pigment and that the at least one different type of metal effect pigment employed in the basecoat composition of the present invention is a silver dollar-shaped metal effect pigment, preferably a silver dollar-shaped aluminum effect pigment. Typically, cornflake-shaped aluminum pigments show a higher LiDAR reflectance at incident angles in the range of 25° to 40°.

Beside the pigment shape the pigment particle size distribution is one characteristic of the at least two metal effect pigments to be used in the basecoat compositions of the present invention.

The particle size distribution is typically represented by the volume-based D10, D50 and D90 values of the pigment particles as determined with a Malvern Zetasizer as described in detail in the experimental part of the specification. D10 defines that the portion of particles with diameters smaller than this value is 10%. D50 defines that the portions of particles with diameters smaller this value are 50% and is also known as the median diameter. D90 defines that the portion of particles with diameters below this value is 90%.

It is preferred that both types of metal effect pigments have a volume-based D90 value of less than 60 μm, more preferably less than 50 μm; a volume-based D50 value of less than 40 μm, more preferably less than 30 μm; and a volume-based D10 value of less than 25 μm, more preferably less than 20 μm. In general, the higher the D50 value is the higher is the loss in LiDAR reflectance, particularly at incident angles in the range of 250 to 40°.

The platelet thickness of such metal effect pigments is preferably in the range of 150 to 1000 nm determined by electron microscopy as described in the experimental section of the description, more preferred 200 to 900 nm, such as 300 to 800 nm. In general, the higher the platelet-thickness, the lower the LiDAR reflectance.

It is most preferred to use at least two different types of metal effect pigments, where the first type has a narrower particle size distribution, while the second type has a broader particle size distribution. How broad or narrow the particle size distribution is, can be determined by calculating the particle size distribution span (PSDS) which is obtained by the following equation: PSDS=[(D90−D10)/(D50)]. The larger the PSDS, the broader the particle size distribution.

It is preferred in the present invention that the difference between the particle size distribution span of the metal effect pigment (B) with the largest PSDS and the metal effect pigment (B) with the smallest PSDS is in the range from 0.2 to 1.0, even more preferably in the range of 0.3 to 0.9, or most preferred in the range of 0.4 to 0.8.

It is also possible and preferred that the basecoat composition contains more than two different types of metal effect pigments, such as three different types of metal effect pigments, preferably three types of aluminum effect pigments.

Preferably, based on the total amount of metal effect pigments (B) each of the two or more different metal effect pigments is present in an amount of at least 5 wt.-%, all amounts of metal effect pigments (B) summing up to 100 wt.-%.

The total amount of all metal effect pigments (B) in the basecoat composition of the present invention is preferably in the range from 0.2 to 8.0 wt.-%, more preferred in the range from 0.5 to 5.0 wt.-% and most preferred in the range from 1.0 to 4.0 wt.-%, based on the total weight of the coating composition.

The weight ratio of (B)/[(A1)+(A2)] in the coating compositions of the present invention is preferably in the range from 0.01 to 0.40, more preferred in the range from 0.02 to 0.30, even more preferred in the range from 0.04 to 0.20 and most preferred in the range from 0.06 to 0.18, such as 0.08 to 0.15.

The metal effect pigments are preferably employed in the coating compositions of the present invention in form of pigment pastes, such pigment pastes preferably contain 40 to 70 wt.-%, more preferably 50 to 65 wt.-% of the metal effect pigments based on the total weight of the pastes. The volatile part is typically an organic solvent such as an alcohol, preferably isopropanol. The pastes may further contain minor amounts of lubricants and other additives.

### Mica Pigments (C)

The platelet-shaped mica pigments (C) to be used in the basecoat compositions of the present invention are LiDAR reflecting pigments as known to one of skill in the art. LiDAR reflecting mica pigments, as used herein, preferably have a LiDAR reflectivity of at least 5% at an angle of incidence of 15°, measured as described in detail in the experimental section by use of an overcoated LENETA® Metopac™ T12G test panel on the black side of the panel.

As mica pigments, natural mica pigments as well as synthetic mica pigments can be used as long as they are LiDAR reflecting.

The term “synthetic mica” as used herein stands for “fluorinated mica” or “fluorine mica”, i.e., a mica, wherein OH groups are replaced by F groups in the respective mica formula.

Unlike natural mica, which is mined in the presence of sand, kaolin, feldspar and other silicates and may contain impurities such as iron oxides and heavy metals, synthetic micas do not contain such impurities. Because of the presence of these additional impurities, natural mica may be discolored. This discoloration is in some cases an undesired characteristic of the natural material. However, it is acceptable, if used in small amounts.

Natural mica must be ground to produce flakes. This grinding process typically does not allow for tight control of the smoothness of the mica surface, stepped characteristics and the thinness of the flake. Accordingly, the flakes often have imperfect edges and faces and less specular reflection (edge scattering).

Synthetic fluorine containing micas can be synthesized as, e.g., described in US 2014/0251184 A1 or using the Bridgman-Stockbarger method making use of platinum crucibles with seeds. Particularly fluorphlogopite is a widely used pigment, having the formula KMg₃AlSi₃O₁₀F₂. This fluorinated mica being the most important one in the present invention and being often used in cosmetic preparations.

In the present invention, amongst the fluorinated micas, particularly preferred fluorphlogopite is used, which is preferably covered or coated with titanium dioxide, iron oxide and/or treated with silanes. How to coat synthetic micas with e.g., titanium dioxide is, e.g., disclosed in EP 3 719 081 A1, but also belongs to the state of the art since most mica products on the market are coated with metal oxides of different composition.

The herein used synthetic and natural mica pigments (C) preferably contain titanium dioxide as a coating. However, small amounts of other oxides in the coating, such as iron oxide and the like are also suitable. Furthermore, some preferred grades may contain silanes as surface-modifiers in amounts of preferably 0 to 3 wt.-% based on the total weight of the pigment (C).

Most preferred as mica pigments (C) are synthetic or natural mica pigments, which are coated and/or surface-treated with one or more titanium oxide minerals. The titanium minerals are preferably selected from the group comprising titanium dioxides such as rutile, anatase and brookite; and iron titanium oxide minerals such as ilmenite. In the present invention it is preferred to use titanium oxide minerals with no or just low contents of iron, preferably not more than 10 wt.-%, even more preferred not more than 8 wt.-% and most preferred not more than 5 wt.-% of iron oxide based on the total pigment weight.

If synthetic or natural mica pigments (C) are used, which comprise titanium oxide minerals, the weight of the mica content based on the total weight of the synthetic or natural mica pigment (C) is preferably in the range from 55 to 90 wt. %, more preferred in the range from 60 to 85 wt.-% and most preferred 65 to 80 wt.-%, while the amount of titanium dioxide is preferably in the range from 10 to 45 wt.-%, more preferred 15 to 40 wt.-% and most preferred from 20 to 35 wt.-%.

The term “synthetic or natural mica pigment (C)” encompasses such coated and/or surface-treated pigments and the total weight of such coated and/or surface-treated mica pigments is understood to be the weight of the “synthetic or natural mica pigment (C)”. Thus, the weight includes the coating material.

The weight ratio of the platelet-shaped mica pigment (C) to the sum of film-forming polymers (A1) and crosslinkers (A2), i.e., (C)/[(A1)+(A2)] is preferably in the range from 0.005 to 0.35, more preferred in the range from 0.010 to 0.30, even more preferred in the range from 0.015 to 0.25 and most preferred in the range from 0.020 to 0.20.

Such mica pigments (C), as employed in the manufacture of the basecoat compositions of the present invention, preferably have a volume-based D90 value of less than 55 μm, more preferred less than 45 μm; a volume-based D50 value of less than 35 μm, more preferred less than 30 μm or even less than 20 μm; and a volume-based D10 value of less than 20 μm, more preferred less than 15 μm; and preferably a platelet thickness from 50 nm to about 400 nm determined by electron microscopy as described in the experimental section of the description. In any case, D90>D50>D10. Particularly preferred D90 values are <35 μm and >20 μm, D50 values are <20 μm and >15 μm and D10 values<15 μm and >3 μm; or D90 values are <25 μm and >15 μm, D50 values are <15 μm and >10 μm and D10 values<10 μm and >3 μm.

Commercially available platelet-shaped LiDAR reflecting mica pigments (C) are e.g., available from Merck KGaA (Darmstadt, Germany) under the tradenames Iriotec® 9870, Iriotec® 9875 and Iriotec® 9880; Iriodin® 9612 SW Silver Grey Fine Satin and Iriodin® 9602 SW Silver Grey; or from SUN Chemical (DIC) under the tradenames Mearlin CFS Bright Silver 1303Z and Mearlin CFS Fine Pearl 1303V.

The mica pigments (C) are preferably present in a range from 0.1 to 6.0 wt.-%, more preferred in a range from 0.2 to 5.0 wt.-%, even more preferred in a range more preferred 0.3 to 4.0 wt.-%, and most preferred in a range from 0.4 to 3.0 wt.-% such as 0.5 to 2.5 wt.-%, based on the total weight of the basecoat composition according to the present invention.

### Component (D)

The inventive coating composition comprises water and/or one or more organic solvents as component (D), said component (D) being present in the coating composition in an amount which is the difference between the weight of the total weight of the composition and its solids content.

When the inventive coating composition mainly comprises water as a volatile component, it is named an aqueous or waterborne composition. In this case it is preferably a coating composition comprising organic solvents in minor proportions.

All conventional organic solvents known to those skilled in the art can be used as organic solvents for the preparation of the coating composition of the invention. The term “organic solvent” is known to those skilled in the art, in particular from Council Directive 1999/13/EC of 11 Mar. 1999. Preferably, the one or more organic solvents are selected from the group consisting of monohydric or polyhydric alcohols, for example, methanol, ethanol, 1-propanol, 2-propanol, 1-butanol, ethylene glycol, ethyl glycol, propyl glycol, butyl glycol, butyl diglycol, 1,2-propanediol and/or 1,3-propanediol; ethers, for example diethylene glycol dimethyl ether; aliphatic hydrocarbons, aromatic hydrocarbons, for example toluene and/or xylenes; ketones, for example acetone, N-methylpyrrolidone, N-ethylpyrrolidone, methyl isobutyl ketone, isophorone, cyclohexanone, methyl ethyl ketone; esters, for example methoxypropyl acetate, ethyl acetate and/or butyl acetate; amides, for example dimethylformamide and mixtures thereof.

### Further Optional Components of the Coating Composition (E)

The inventive coating composition may optionally comprise one or more components (E), which are different from each of components (A1), (A2). (B), (C) and (D).

The coating composition of the present invention may contain one or more commonly used additives (E) depending on the desired application. For example, the coating composition may comprise at least one additive selected from the group consisting of reactive diluents, such as polypropylene diols, light stabilizers, antioxidants, deaerators, emulsifiers, slip additives, polymerization inhibitors, plasticizers, initiators for free-radical polymerizations, adhesion promoters, flow control agents, film-forming auxiliaries, sag control agents (SCAs), flame retardants, corrosion inhibitors, siccatives, biocides and/or matting agents. They can be used in the known and customary proportions. Preferably, their content, based on the total weight of the coating composition according to the invention is 0.01 to 25 wt.-%, more preferably 0.05 to 20 wt.-%, particularly preferably 0.1 to 15% by weight, most preferably from 0.1 to 10% by weight, especially from 0.1 to 7% by weight and most preferably from 0.1 to 5% by weight.

Amongst the additives, the coating composition according to the invention may optionally contain at least one thickener or rheology agent. Examples of such thickeners are inorganic thickeners, for example metal silicates such as sheet silicates, and organic thickeners, for example poly(meth)acrylic acid thickeners and/or (meth)acrylic acid (meth)acrylate copolymer thickeners, polyurethane thickeners and polymeric waxes. The metal silicate is preferably selected from the group of smectites. The smectites are particularly preferably selected from the group of montmorillonites and hectorites. In particular, the montmorillonites and hectorites are selected from the group consisting of aluminum-magnesium silicates and sodium-magnesium and sodium-magnesium fluorine-lithium phyllosilicates. These inorganic phyllosilicates are marketed, for example, under the trademark Laponite®. Thickeners based on poly(meth) acrylic acid and (meth) acrylic acid (meth) acrylate copolymer thickeners are optionally crosslinked and or neutralized with a suitable base. Examples of such thickening agents are “Alkali Swellable Emulsions” (ASE), and hydrophobically modified variants thereof, the “Hydrophobically Modified Alkali Swellable Emulsions” (HASE). Preferably, these thickeners are anionic. Corresponding products such as Rheovis® AS 1130 are commercially available. Polyurethane based thickeners (e.g., polyurethane associative thickeners) are optionally crosslinked and/or neutralized with a suitable base. Corresponding products such as Rheovis® PU 1250 are commercially available. Examples of suitable polymeric waxes are optionally modified polymeric waxes based on ethylene-vinyl acetate copolymers. A corresponding product is commercially available, for example, under the name Aquatix® 8421.

It at least one thickener is present in the coating composition according to the invention, it is preferably present in an amount of at most 10% by weight, more preferably at most 8% by weight, most preferably at most 4% by weight, especially at most 2% by weight. %, most preferably not more than 1% by weight, based in each case on the total weight of the coating composition. The minimum amount of thickener is preferably in each case 0.1% by weight, based on the total weight of the coating composition.

The further optional ingredients (E) may also be pigments which differ from the metal effect pigments (B) and mica pigments (C). Such pigments are particularly used for tinting purposes, preferably for tinting purposes only.

If further pigments (E) are contained, they should preferably be LiDAR reflecting or LiDAR transparent, in particular not LiDAR absorbing.

If LiDAR absorbing further pigments (E), such as carbon blacks, are used in the basecoats of the present invention, they should preferably be contained in tinting amounts, only. The term “tinting amount” as used herein refers to an amount of preferably in the range from 0.005 to 0.5 wt.-%, more preferably in the range from 0.01 to 0.3 wt.-% and most preferably in the range from 0.015 to 0.15 wt.-% such as from 0.020 to 0.10 wt.-% based on the total weight of the basecoat composition of the invention. However, the use of LiDAR absorbing pigments is not preferred in the present invention, since their use typically leads to a decrease of LiDAR reflectance in the desired incident angle range.

LiDAR reflecting or LiDAR transparent further pigments (E) can be contained in higher amounts of preferably 0.01 to 4.0 wt.-%, more preferably 0.020 to 2.5 wt.-%, even more preferred in the range from 0.025 to 1.5 wt.-% such as 0.030 to 1 wt.-% based on the total weight of the basecoat composition of the invention.

As used herein, a pigment (E) is considered to be a LiDAR reflecting pigment, if it shows a LiDAR reflectivity of at least 15%, measured as described in detail in the experimental section by use of an overcoated LENETA® Metopac™ T12G test panel on the black side of the panel; and if it shows a LiDAR reflectivity of at least 50%, measured as described in detail in the experimental section by use of an overcoated LENETA® Metopac™ T12G test panel on the white side of the panel. Measurements of color pigments (E) are performed only at a 0° angle.

Suitable LiDAR transparent pigments (E) are e.g., perylene based pigments, as being available under the tradenames Spectrasense® Black L0086, formerly known as Paliogen® Black L0086, Spectrasense® Black K0087, formerly known as Lumogen® Black K0087 and Spectrasense® Black EH8082, while suitable LiDAR reflective pigments (E) may be of a mixed metal oxide type and e.g., being available under the tradename Sicopal® Black L0095.

Typically, almost all organic color pigments are LiDAR transparent and show similar behavior at 1550 nm. At 905 nm some differences can be observed, e.g., a pigment blue 60 such as Paliogen® Blue L 6480 from SUN Chemical (DIC) performs less good compared to a pigment yellow 139 Paliotan® Yellow L2145H from SUN Chemical (DIC).

The preparation of the coating composition can be carried out using customary and known preparation and mixing methods and mixing units, or using conventional dissolvers and/or stirrers.

### Coating Layers

A further subject-matter of the present invention is a coating layer, obtainable from the inventive basecoat composition, in particular by applying the inventive coating composition onto a substrate, preferably according to an inventive method as disclosed below.

All preferred embodiments described herein above in connection with the inventive coating composition and the preferred embodiments thereof are also preferred embodiments of the inventive coating layer, i.e., the inventive basecoat layer.

Preferably, the inventive basecoat layer is present at least partially on the surface of a substrate, said substrate preferably being coated with a light-grey colored or white primer layer.

The inventive coating is able to reflect near-infrared (NIR) light having a wavelength from 700 to 1560 nm.

Inventive Method of Forming a Coating Layer and/or Multilayer Coating

A further subject-matter of the present invention is a method of forming a coating layer at least partially onto at least one surface of a substrate, wherein said method comprises at least step (a), namely
(a) applying the inventive basecoat composition at least partially onto at least one surface of an optionally pre-coated substrate to form a basecoat layer on the surface of the substrate.

A further subject-matter of the present invention is a method of forming a cured basecoat layer at least partially onto at least one surface of a substrate, wherein said method comprises at least step (a) as defined above and at least step (b), namely
(b) curing the basecoat layer obtained after performing of step (a) to form a cured coating on the surface of the substrate.

If the substrate is precoated with a primer coating composition to form a primer coating, the primer coating is preferably light-colored, such light-grey colored or white. Preferably the primer coating compositions and thus the primer coating or primer coating layer contains as main pigment titanium dioxide. The term “main” pigment means that no other pigment in the primer coating compositions is contained in a higher amount than the main pigment.

When the inventive coating composition is a—preferably aqueous—basecoat coating composition, step (a) or steps (a) and (b) is/are preferably carried out onto at least one surface of a pre-coated substrate. If the substrate is a metal substrate, said metal substrate then preferably bears a primer and/(or) an electrodeposition coating as pre-coating layers and/(or) a conversion coating layer as pre-treatment.

Independent of the substrate used, after having performed step (a) or steps (a) and (b), preferably a clearcoat composition is applied onto the basecoat coat in step (c) to form a clearcoat layer. The clearcoat can be cured separately or simultaneously with the basecoat layer or simultaneously with the primer layer and basecoat layer.

It has been found by the present inventors that it is particularly preferred with respect to LiDAR reflectivity to use a clearcoat composition producing a matt clearcoat layer. Such clearcoat compositions forming matt clearcoat layers contain one or more matting agents. The matting agents can be any known matting agents in the art of coatings, preferably selected from the group consisting of synthetic silica gels including precipitation silica gels and agglomeration-precipitation silica gels; natural silica gels such as diatomaceous earth; wax-treated or polymer-treated silica gels; waxes; talcum; and micronized polymers such as micronized urea-formaldehyde resins. More preferred the matting agents are selected from the group consisting of synthetic silica gels including precipitation silica gels and agglomeration-precipitation silica gels and wax-treated or polymer-treated silica gels. Most preferably the matting agents are selected from the group consisting of polymer-treated silica, as e.g., ACEMATT 3300 (Evonik), silica gel, as e.g., SYLOID C 2006 (Grace) and or wax after-treated precipitated silica as e.g., ACEMATT OK 412 (Evonik). The amount of matting agent in such clearcoat compositions is preferably in the range from 0.1 wt.-% to 25 wt.-%, more preferred in the range from 0.5 wt.-% to 20% wt.-% and most preferred in the range of 1.0 wt-% to 10% wt.-% such as 2.0 wt.-% to 8 wt.-%, based on the total weight of the clearcoat composition.

Particularly preferred is a method of forming a multilayer coating comprising the steps of
(a) applying the inventive basecoat composition at least partially onto at least one surface of substrate preferably coated with a preferably white or grey, more preferred white filler coating layer to form a basecoat layer on the surface of said substrate; and
(b) applying a glossy or matt clearcoat composition, preferably a matt clearcoat composition onto the basecoat layer to obtain a clearcoat layer; and
(c) curing the basecoat layer before applying the clearcoat or curing the basecoat layer simultaneously with the clearcoat layer, wherein at least one of the filler coating layer or the clearcoat layer is present.

Even more preferred is a method of forming a multilayer coating comprising the steps of
(a) applying the inventive basecoat composition at least partially onto at least one surface of substrate coated with a preferably white or grey, more preferred white filler coating layer to form a basecoat layer on the surface of said substrate; and (b) applying a glossy or matt, preferably matt clearcoat composition onto the basecoat layer to obtain a clearcoat layer; and
(c) curing the basecoat layer before applying the clearcoat or curing the basecoat layer simultaneously with the clearcoat layer.

Most preferred is a method of forming a multilayer coating comprising the steps of
(a) applying the inventive basecoat composition at least partially onto at least one surface of substrate coated with a white filler coating layer to form a basecoat layer on the surface of said substrate; and
(b) applying a matt clearcoat composition onto the basecoat layer to obtain a clearcoat layer; and
(c) curing the basecoat layer before applying the clearcoat or curing the basecoat layer simultaneously with the clearcoat layer.

The inventive basecoat composition, as well as the primer composition and/or clearcoat composition can be coated on an object by numerous techniques well-known in the art, including spray coating, drop coating, dip coating, roll coating, curtain coating, and other techniques. Preferably, the inventive coating compositions are applied by spray coating, more preferred by pneumatic or electrostatic spray coating. It can be applied wet-on-wet, but does not have to.

All preferred embodiments described herein above in connection with the inventive coating composition, the inventive coating and the preferred embodiments thereof, are also preferred embodiments of the inventive methods of forming a (cured) coating.

### Substrate

A further subject-matter of the present invention is an at least partially coated substrate obtainable by the inventive method.

If a metal substrate is used to produce the coated substrate, such metal is preferably steel, galvanized steel, aluminum or alloys of these. Metal substrates are preferably pretreated and/or precoated, most preferably bearing a primer and/(or) an electrodeposition coating as pre-coating layers and/(or) a conversion coating layer as pre-treatment of the metal surface.

Further, the substrate used can be glass or a textile substrate, in particular glass.

If the substrate is a plastic (polymeric) substrate, it may also be a pre-coated substrate, which, e.g., bears a primer coating, but does not have to.

If plastic (polymeric) substrates are used, preferably, thermoplastic polymers are used as such substrates. Suitable polymers are poly(meth)acrylates including polymethyl(meth)acrylates, polybutyl (meth)acrylates, polyethylene terephthalates, polybutylene terephthalates, polyvinylidene fluorides, polyvinyl chlorides, polyesters, including polycarbonates and polyvinyl acetate, polyamides, polyolefins such as polyethylene, polypropylene, polystyrene, and also polybutadiene, polyacrylonitrile, polyacetal, polyacrylonitrile-ethylene-propylene-diene-styrene copolymers (A-EPDM), ASA (acrylonitrile-styrene-acrylic ester copolymers) and ABS (acrylonitrile-butadiene-styrene copolymers), polyetherimides, phenolic resins, urea resins, melamine resins, alkyd resins, epoxy resins, polyurethanes, including TPU, polyetherketones, polyphenylene sulfides, polyethers, polyvinyl alcohols, and mixtures thereof. Polycarbonates and poly(meth)acrylates are especially preferred. The substrate can also be a composite substrate such as a fiber reinforced substrate containing e.g., glass fibers, carbon fibers or polymeric fibers such as polyamide fibers. The substrate can also consist of multiple polymeric layers.

The coated substrates can be used to produce, e.g., automotive bodies and parts thereof.

All preferred embodiments described above herein in connection with the inventive coating composition, the inventive coating layer, as well as the inventive methods of forming a coating film and a coating, and the preferred embodiments thereof, are also preferred embodiments of the inventive substrate.

The method of forming a coating layer at least partially onto at least one surface of a substrate—as defined above—comprising
(a) applying the inventive basecoat composition at least partially onto at least one surface of an optionally pre-coated substrate to form a basecoat layer on the surface of the substrate; and
(b) curing the basecoat layer obtained after performing of step (a) to form a cured coating on the surface of the substrate,
   is also suitable as method of improving the LiDAR reflectivity and/or LiDAR detectability of objects, wherein the substrate is the object or becomes part of the object, which is to be improved in view of LiDAR reflectivity and/or LiDAR detectability.

Further preferred features and embodiments of the method of improving the LiDAR reflectivity and/or LiDAR detectability of object, are the same as for the method of forming a coating layer at least partially onto at least one surface of a substrate. This applies particularly in view of the substrates, filler coating compositions or primer coating compositions and clearcoat compositions used in said method; and also, for the pre-treatment and pre-coating of the substrates used in the method. Of course, any preferred features or embodiments of the basecoat compositions of the invention can be used in the method of improving the LiDAR reflectivity and/or LiDAR detectability. The application parameters and techniques are the same as described for the method of forming a coating layer at least partially onto at least one surface of a substrate.

Furthermore, the method of forming a multilayer coating comprising the steps of
(a) applying the inventive basecoat composition at least partially onto at least one surface of substrate preferably coated with a preferably white or grey, more preferably white filler coating layer to form a basecoat layer on the surface of said substrate; and
(b) preferably applying a glossy or matt clearcoat composition, preferably a matt clearcoat composition, onto the basecoat layer to obtain a clearcoat layer; and
(c) curing the basecoat layer before applying the clearcoat or curing the basecoat layer simultaneously with the clearcoat layer,
   wherein at least one of the filler coating layer or the clearcoat layer is present,
   is also suitable as method of improving the LiDAR reflectivity and/or LiDAR detectability of objects, wherein the substrate is the object or becomes part of the object, which is to be improved in view of LiDAR reflectivity and/or LiDAR detectability.

Further preferred features and embodiments of the method of improving the LiDAR reflectivity and/or LiDAR detectability of object, are the same as for the method of forming a multilayer coating on at least partially onto at least one surface of a substrate. This applies particularly in view of the substrates, filler coating compositions or primer coating compositions and clearcoat compositions used in said method; and also, for the pre-treatment and pre-coating of the substrates used in the method. Of course, any preferred features or embodiments of the basecoat compositions of the invention can be used in the method of improving the LiDAR reflectivity and/or LiDAR detectability. The application parameters and techniques are the same as described for the method of forming of forming a multilayer coating at least partially onto at least one surface of a substrate.

### Use

A further subject-matter of the present invention is a use of the inventive coatings and/or the inventive at least partially coated substrates and/or objects produced from said substrates in LiDAR visibility applications, in particular for autonomous systems such as self-driving vehicles and vehicles with ADAS. Of course, the coating material can also be applied to non-autonomous vehicles and parts thereof to make such vehicles and parts thereof LiDAR reflective for detection by other vehicles, such as autonomous vehicles.

All preferred embodiments described above herein in connection with the inventive coating composition, the inventive coating film, the inventive coating, as well as the inventive methods of forming a coating film and a coating and the inventive partially coated substrate, and the preferred embodiments thereof, are also preferred embodiments of the inventive use.

The inventive use allows a benefit from better infrared light and LiDAR visibility, in particular for autonomous systems such as self-driving vehicles and vehicles with ADAS.

### EXAMPLES

### Methods

### Determination of the Solids Content

The nonvolatile fraction (solids content) is determined according to DIN EN ISO 3251 (date: June 2008). It involves weighing out 1 g of sample into an aluminum dish which has been dried beforehand, drying it in a drying oven at 125° C. for 60 minutes, cooling it in a desiccator and then reweighing it. The residue relative to the total amount of sample used corresponds to the nonvolatile fraction. The volume of the nonvolatile fraction may optionally be determined if necessary, according to DIN 53219 (date: August 2009).

### Volume-Based D10, D50 and D90 Values

The afore-mentioned parameters were determined by use of the above Malvern Zetasizer (from Malvern, S90 unit, Nanoseries Model ZEN 1690 mfg May 2017) using dynamic light scattering. To carry out the measurements, the pigment dispersions were diluted with appropriate solvent (deionized water for aqueous dispersion and organic solvent for solvent-based dispersion) not to exceed a photon count rate of approx. 300 to 500 counts when the unit is placed on an attenuator setting of 7. The operation temperature is held a 25±1° C. and the sample size is approx. 10 to 15 mL (square glass cuvette).

The procedure was as follows:

Typically, the photon count rate is in the above range, if 0.07 g of a paste containing 20 wt.-% of the pigment is first diluted into 15.0 g of deionized water and subsequently 5 drops of this solution are again diluted in to 15.0 g of deionized water. If the pigment paste contains more or less than 20 wt.-% of the pigment, the initial amount of 0.07 g should be decreased or increased accordingly.

With such twice-diluted paste the volume-based D10, D50 and D90 values were determined.

### Determination of the Platelet-Thickness of Pigments

The platelet-thickness can be determined as follows: First the flake pigment is dispersed in appropriate solvent and incorporated in the basecoat composition. Then, a basecoat composition containing the platelet-shaped pigment is sprayed on a substrate and cured. The thus obtained film was peeled off from the edge of the sample and small pieces of films were cut by microtome using a diamond knife and thin sections were transferred onto TEM grids. Thin sections were examined on STEM or TEM to determine the thickness of the respective flake pigment.

### Determination of LiDAR Reflectivity of Mica Pigments (C) and Further Pigments (E)

To determine the LiDAR reflectivity of pigments, coatings were prepared and applied as follows:

As substrates Metopac™ T12G Test Panels from LENETA were used (which is also widely used in ASTM D 6441). The lightness value L of the black part of the panels in the Lab system at the 15° angle is 3.60, while the lightness value L of the white part of the panel in the Lab system at the 15° angle is 94.08.

Effect pigments, such as the mica pigments (C), or other platelet-shaped pigments, such as glass platelets (E), were dispersed in a standard coating composition, which is described in Table A and the dispersion was subsequently applied in masstone on Metopac™ T12G Test Panels, obtaining a dry layer thickness of 17.5±2.5 μm layer thickness at a pigment to binder ratio of 0.2. LiDAR reflectance is measured in dependance of the incidence angle on both, the white and black part of the substrate.

Further pigments (E), particularly color pigments (E) were dispersed and applied in the same way as effect pigments, however in a dry layer thickness of 20 μm at a pigment to binder ratio of 0.3. LiDAR reflectance of color pigments (E) was measured only at the incidence angle of 0° (perpendicular) on both, the white and black part of the substrate.

The term “binder” as used throughout the present invention and in accordance with EN ISO 4618:2006 (German version) means the solids content (i.e., the non-volatile content) without pigments and fillers. In this context layered silicates and silicas are considered as fillers, although they might possess further properties, e.g., thickening properties.

Subsequently, and prior to the measurement, a clearcoat layer (approx. 50 μm dry film thickness) formed from a polyol and an isocyanate hardener (ProGloss) containing UV stabilizers was applied and cured.

The angle-dependent LiDAR reflectivity of the samples was measured with a Velodyne VLP-16 LiDAR sensor firing at 905 nm. The sensor was mounted at a distance of about 1 m from the samples and moved along a circular path around the sample center, so that the angle of incidence of the LiDAR radiation on the sheet was changed in 5° steps from 0° to 600.

The LiDAR reflectivity of different micas (C) and further pigments (E) as determined above is shown in Table B.

### Preparation of Coated Substrates

The test panels were prepared as follows. A cold-rolled steel panel pretreated by conversion coating and precoated with a cathodic electrodeposition coating composition (zinc phosphated CRS panel, e-coated with CathoGuard® 800) was spray-coated by ESTA with a white or grey primer, composed as specified in Table 1. The thus obtained primer layer was cured for 20 minutes at 160° C. The thus obtained primer layers had dry-layer thicknesses of approx. 25 μm.

On the thus obtained primer layer, basecoat compositions C and E1 to E13 (composed as described in Tables 2 and 3; characteristics of mica pigments (C) and further pigments (E) are shown in Table B and characteristics of aluminum effect pigments (B) are shown in Table C) were applied by spray-coating. After a flash-off for 10 min at 80° C. the thus obtained basecoat layers had dry-layer thicknesses of approx. 12 μm.

On the thus obtained basecoat layers, clearcoat compositions (composed as described in Table 4) were applied by spray-coating ESTA. The thus obtained clearcoat layer was cured for 17 minutes at 140° C. The thus obtained clearcoat layers had dry-layer thicknesses of approx. 40 μm.

TABLE A

| | | Solvent Content | | | | |
|---|---|---|---|---|---|---|
| | | of Ingredients | | | Amounts | Binder |
| | | [wt.-%] | | | [parts by | [parts by |
| Ingredients | Tradename | organic | H₂O | Type | weight] | weight] |
| OH-funct. Polyester 1 based on Dimeric Acid (60 wt.-% solids) | Parotal EF 82.6¹ | 22.3 | 17.7 | Binder | 3.00 | 1.80 |
| OH-funct Polyester 2 based on Dimeric Acid (60 wt.-% solids) | Parotal EF 83.6¹ | 22.3 | 17.7 | Binder | 0.28 | 0.17 |
| OH-funct Polyurethane 1 based on IPDI (27 wt.-% solids) | Parodur EL 48.6¹ | 7.0 | 66.0 | Binder | 28.20 | 7.61 |
| OH-funct Polyacrylate Core/Shell dispersion (35 wt.-% solids) | Parocryl 567750/033¹ | 13.2 | 61.8 | Binder | 5.17 | 1.81 |
| Low imino, highly methyl-, butyl-alkylated melamine | Cymel 3020² | 0.1 | 0.0 | Binder | 5.64 | 5.58 |
| formaldehyde resin (99.9 wt.-% solids) | | | | | | |
| Rheology Control Agent 3 (layered silicate, 100 wt.-% solids) | Laponite RD³ | 0.0 | 0.0 | Filler | 0.82 | — |
| Rheology Control Agent 4 (polyacrylate, 30 wt.-% solids) | Rheovis AS 1130 30% W⁴ | 0.0 | 70.0 | Binder | 0.28 | 0.08 |
| Rheology Control Agent 5 (polyurethane type, 41 wt.-% solids) | Rheovis PU 1250⁴ | 19.0 | 40.0 | Binder | 0.24 | 0.10 |
| 2,4,7,9-tetramethyl-5-decyne-4,7-diol (52 wt.-% solids) | TMDD BG 52⁵ | 48.0 | 0.0 | Binder | 1.48 | 0.77 |
| Biocide (14 wt.-% solids) | Acticide MBR1⁶ | 0.0 | 86.0 | Binder | 0.03 | 0.00 |
| Matting Agent (synth. amorphous silica, 100 wt.-% solids) | Syloid ED 3⁷ | 0.0 | 0.0 | Filler | 0.11 | — |
| Dimethylethanolamine | — | 0.0 | 0.0 | Binder | 0.11 | 0.11 |
| Wetting/Plasticizing Agent (polypropylene glycol, 99 wt. % solids) | Polypropylenglykol 1010⁸ | 1.0 | 0.0 | Binder | 0.82 | 0.81 |
| Ethylhexanol | — | 100.0 | 0.0 | Solvent | 1.88 | — |
| Butylglycol | — | 100.0 | 0.0 | Solvent | 5.55 | — |
| Demineralized Water | — | 0.0 | 100.0 | Solvent | 46.40 | — |

| | | |
|---|---|---|
| Sum | 100.00 | 18.84 |

¹commercially available from BASF Coatings GmbH
²commercially available from Allnex GmbH (Germany)
³commercially available from BYK-Chemie GmbH (Wesel, Germany)
⁴commercially available from BASF SE
⁵commercially available from BASF SE
⁶commercially available from Thor GmbH (Speyer, Germany)
⁷commercially available from W. R. Grace & Co
⁸commercially available from BASF SE oder DOW Chemical

TABLE B
Characteristics of mica pigments (C) and further pigments (E)

| | | | | | Particle Size |
|---|---|---|---|---|---|
| | | | Incidence | | Distribution |
| Basecoat | | | Angle [°] | | D10/D50/D90 |
| [Table(s)] | Names in Tables 2 and 3, Chemistry | Tradename | 15 | 35 | [μm] |

Micas (C)

| | | | | | |
|---|---|---|---|---|---|
| 2 | Synthetic Mica 1* (Fluorphlogopite), | Symic OEM Medium | 7.36 | 0.0 | 12/22.5/40 |
| | TiO₂ and silane treated | Pearlescent Silver^{a} | | | |
| 2 | Synthetic Mica 2** (Fluorphlogopite), | Symic OEM Medium | 6.90 | 0.0 | 12/22.5/40 |
| | TiO₂/Fe₂O₃/silane treated | Opaque Silver^{a} | | | |
| 2 | Natural Mica 1, TiO₂ coated, chrome- | Mearlin CFS Fine | 21.62 | 1.3 | 5/11/22 |
| | free treatment | Pearl 1303V^{b} | | | |
| 3 | Natural Mica 2, TiO₂ coated, chrome- | Mearlin CFS Bright | 20.59 | 0.56 | 11, 3/18, |
| | free treatment | Silver 1303Z^{b} | | | 8/34, 5 |
| 3 | Natural Mica 3, TiO₂ coated, with lilac | Iriotec 9875^{c} | 36.72 | 6.15 | (5-25) |
| | interference color | | | | |

Further Pigments (E)

| | | | | | |
|---|---|---|---|---|---|
| 2, 3 | Glass platelets (white), TiO₂ coated, | Luxan CFX C0001^{a} | 2.05 | 0.00 | 17, 5/32, |
| | SiO₂ surface treated | | | | 5/60, 5 |

^{a}Eckart GmbH
^{b}SUN Chemical
^{c}Merck KGaA
*contains approx. 74.5 wt.-% fluorophlogopite, 25 wt.-% TiO₂ and no iron oxide
**contains approx. 72.5 wt.-% fluorophlogopite, 24 wt.-% TiO₂ and 3 wt.-% iron oxide

TABLE C
Characteristics of aluminum effect pigments (B)

| | | | | Particle Size |
|---|---|---|---|---|
| | | | | Distribution |
| Basecoat | | | | D10/D50/ |
| [Table(s)] | Names in Tables 2 and 3, Chemistry | Type | Tradename | D90 [μm] |
| 2 | Al Effect Pigment 1, Cr₂O₃ treated | silverdollar | ALU STAPA ® | 7/20/42 |
| | (65 wt.-% solids) | | HYDROLUX 600^{a} | |
| 2 | Al Effect Pigment 2, Cr₂O₃ treated | silverdollar | ALU STAPA ® | 5/14/28 |
| | (66.5 wt. % solids) | | HYDROLUX 51270/G^{a} | |
| 2 | Al Effect Pigment 3, Cr₂O₃ treated | cornflake | ALU STAPA ® | 10/20/32 |
| | (66.5 wt.-% solids) | | HYDROLUX 2156^{a} | |
| 3 | Al Effect Pigment 4, SiO₂ treated | silverdollar | ALU STAPA ® IL | 11/22/36 |
| | (65 wt.-% solids) | | HYDROLAN 8154^{a} | |
| 3 | Al Effect Pigment 5, SiO₂ treated | cornflake | ALU STAPA ® IL | 15/26/40 |
| | (60 wt. % solids) | | HYDROLAN 2153^{a} | |
| 3 | Al Effect Pigment 6, SiO₂ treated | cornflake | ALU STAPA ® IL | 5/14/28 |
| | (60 wt.-% solids) | | HYDROLAN 9160^{a} | |

^{a}Eckart GmbH

TABLE 1
Primer Compositions

| | Amounts [parts | |
|---|---|---|
| | by weight] | |
| | White | Grey |
| Ingredients | Primer | Primer |
| Anionic waterborne polyester resin 1 | 20.500 | 20.353 |
| Anionic waterborne polyester resin 2 | 0.006 | 0.000 |
| Hydroxyl-functional polyurethane dispersion 1 (hexamethylene | 13.549 | 5.673 |
| diisocyanate based) | | |
| Hydroxyl-functional polyurethane dispersion 2 (hexamethylene | 26.800 | 22.119 |
| diisocyanate based)//capped HDI-trimer premix) | | |
| Acrylate-polyurethane graft copolymer | 0.009 | 0.000 |
| Aminoplast resin crosslinker 1 (imino type, highly reactive, | 3.400 | 4.761 |
| methylated melamine-formaldehyde resin, 90 wt.-% in iso-BuOH) | | |
| Aminoplast resin crosslinker 2 (methylated/n-butylated | 3.400 | 0.000 |
| melamine-formaldehyde resin) | | |
| Tinter 1 (Titanium Dioxide; PW6) | 20.500 | 18.740 |
| Tinter 2 (Iron Oxide Hydroxide; PY42) | 0.000 | 0.140 |
| Tinter 3 (Red iron Oxide; PR101) | 0.000 | 0.080 |
| Tinter 4 (Quinacridone; PR122) | 0.001 | 0.000 |
| Tinter 5 (Indanthrone; PB60) | 0.005 | 0.000 |
| Tinter 6 (Carbon Black) | 0.000 | 0.132 |
| Tinter 7 (Gas Carbon Black; PB7) | 0.001 | 0.000 |
| Filler (talc and/or micronized talc) | 0.500 | 2.250 |
| Rheology Control Additive 1 (35 wt.-% in water) | 0.500 | 0.476 |
| Rheology Control Additive 2 (Hydrophilic pyrogenic silica) | 0.000 | 0.476 |
| Water (demineralized) | 4.541 | 14.521 |
| Dimethylethanolamine | 0.086 | 0.174 |
| Solvent Mixture 1 (ethyl hexanol/dipropylene glycol | 0.000 | 0.952 |
| butylether; 26/74 w/w) | | |
| Solvent Mixture 2 (butyl diglycol/dipropylene glycol | 2.601 | 0.000 |
| methylether; 1/1 w/w) | | |
| C10/C13-n-Paraffine | 2.000 | 5.177 |
| 2,2,4-trimethylpentandiol monoisobutyrate | 0.000 | 2.777 |
| Polysiloxane based wetting additive 1 | 0.500 | 0.000 |
| Polysiloxane based wetting additive 2 (45 wt.-% in dipropylene | 0.500 | 0.823 |
| glycol methylether) | | |
| Matting agent (synthetic amorphous silica) | 0.400 | 0.000 |
| Wetting and Dispersing Additive 1 (block copolymer, 52 wt.-% | 0.001 | 0.000 |
| in dipropylene glycol methylether/propylene glycol, 2/1, w/w) | | |
| Wetting and Dispersing Additive 2 (polyacrylate; 50 wt.-% in | 0.000 | 0.188 |
| organic solvents) | | |
| 2,4,7,9-Tetramethyl-5-decyne-4,7-diol | 0.200 | 0.188 |
| Sum | 100.000 | 100.000 |

TABLE 2
Basecoat Compositions

| | Solvent Content | | | | | | | | | |
|---|---|---|---|---|---|---|---|---|---|---|
| | of Ingredients | | | | | | | | | |
| | [wt.-%] | | | Amounts [parts by weight] | | | | | | |
| Ingredients | organic | H₂O | Type | C | E1 | E2 | E3 | E4 | E5 | E6 |
| OH-funct. Polyester 1 based on Dimeric Acid | 22.3 | 17.7 | A1 | 2.757 | 2.757 | 2.757 | 2.757 | 2.757 | 2.757 | 2.757 |
| (60 wt.-% solids) | | | | | | | | | | |
| OH-funct Polyester 2 based on Dimeric Acid | 22.3 | 17.7 | A1 | 0.275 | 0.257 | 0.257 | 0.257 | 0.257 | 0.257 | 0.256 |
| (60 wt.-% solids) | | | | | | | | | | |
| OH-funct Polyurethane 1 based on IPDI | 7.0 | 66.0 | A1 | 27.450 | 25.651 | 25.651 | 25.651 | 25.671 | 25.671 | 25.582 |
| (27 wt.-% solids) | | | | | | | | | | |
| OH-funct Polyurethane 2 based on TMXDI | 5.6 | 62.0 | A1 | 0.105 | 0.105 | 0.105 | 0.105 | 0.053 | 0.053 | 0.053 |
| (32.4 wt.-% solids) | | | | | | | | | | |
| OH-funct Polyacrylate Core/Shell dispersion | 13.2 | 61.8 | A1 | 5.033 | 4.703 | 4.703 | 4.703 | 4.707 | 4.707 | 4.690 |
| (35 wt.-% solids) | | | | | | | | | | |
| Low imino, highly methyl-, butyl-alkylated melamine | 0.1 | 0.0 | A2 | 5.033 | 4.703 | 4.703 | 4.703 | 4.707 | 4.707 | 4.690 |
| formaldehyde resin (99.9 wt.-% solids) | | | | | | | | | | |
| Al Effect Pigment 1, silverdollar, Cr₂O₃ treated | 20.0 | 15.0 | B | 2.261 | 2.261 | 2.261 | 2.261 | 2.261 | 2.261 | 2.261 |
| (65 wt.-% solids) | | | | | | | | | | |
| Al Effect Pigment 2, silverdollar, Cr₂O₃ treated | 20.5 | 13.0 | B | 0.248 | 0.248 | 0.248 | 0.248 | 0.248 | 0.248 | 0.248 |
| (66.5 wt. % solids) | | | | | | | | | | |
| Al Effect Pigment 3, cornflake, Cr₂O₃ treated | 20.0 | 13.5 | B | 0.248 | 0.248 | 0.248 | 0.248 | 0.248 | 0.248 | 0.248 |
| (66.5 wt.-% solids) | | | | | | | | | | |
| Synthetic Mica 1 (Fluorphlogopite), TiO₂ and silane | 0.0 | 0.0 | C | 0.000 | 1.500 | 0.000 | 0.000 | 1.500 | 0.000 | 1.000 |
| treated | | | | | | | | | | |
| Synthetic Mica 2 (Fluorphlogopite), TiO₂/iron | 0.0 | 0.0 | C | 0.000 | 0.000 | 1.500 | 0.000 | 0.000 | 0.000 | 0.000 |
| oxide/silane treated | | | | | | | | | | |
| Natural Mica 1, TiO₂ coated, chrome-free treatment | 0.0 | 0.0 | C | 0.000 | 0.000 | 0.000 | 1.500 | 0.000 | 1.500 | 0.000 |
| Glass platelets (white), TiO₂ coated, SiO₂ surface | 0.0 | 0.0 | E | 0.000 | 0.000 | 0.000 | 0.000 | 0.000 | 0.000 | 0.506 |
| treated | | | | | | | | | | |
| Colorant 1 (phthalocyanine, PB15/PG7, 1/1, | 0.0 | 0.0 | E | 0.021 | 0.021 | 0.021 | 0.021 | 0.011 | 0.011 | 0.011 |
| 100 wt.-% solids) | | | | | | | | | | |
| Rheology Control Agent 3 (layered silicate, | 0.0 | 0.0 | E | 0.769 | 0.718 | 0.718 | 0.718 | 0.719 | 0.719 | 0.716 |
| 100 wt.-% solids) | | | | | | | | | | |
| Rheology Control Agent 4 (polyacrylate, | 0.0 | 70.0 | E | 0.458 | 0.549 | 0.549 | 0.549 | 0.549 | 0.549 | 0.544 |
| 30 wt.-% solids) | | | | | | | | | | |
| Rheology Control Agent 5 (polyurethane type, | 19.0 | 40.0 | E | 0.229 | 0.214 | 0.214 | 0.214 | 0.214 | 0.214 | 0.213 |
| 41 wt.-% solids) | | | | | | | | | | |
| Dispersing Agent (aliphatic, acidic polyether, | 0.0 | 0.0 | E | 0.000 | 0.144 | 0.144 | 0.144 | 0.144 | 0.144 | 0.139 |
| 100% solids) | | | | | | | | | | |
| 2,4,7,9-tetramethyl-5-decyne-4,7-diol | 48.0 | 0.0 | E | 1.441 | 1.747 | 1.747 | 1.747 | 1.748 | 1.748 | 1.731 |
| (52 wt.-% solids) | | | | | | | | | | |
| Biocide (14 wt.-% solids) | 0.0 | 86.0 | E | 0.026 | 0.024 | 0.024 | 0.024 | 0.024 | 0.024 | 0.024 |
| Matting Agent (synth. amorphous silica, | 0.0 | 0.0 | E | 0.110 | 0.103 | 0.103 | 0.103 | 0.103 | 0.103 | 0.102 |
| 100 wt.-% solids) | | | | | | | | | | |
| Dimethylethanolamine | 0.0 | 0.0 | E | 0.139 | 0.145 | 0.145 | 0.145 | 0.145 | 0.145 | 0.144 |
| Wetting/Plasticizing Agent (polypropylene glycol, | 1.0 | 0.0 | E | 0.772 | 0.722 | 0.722 | 0.722 | 0.721 | 0.721 | 0.718 |
| 99 wt. % solids) | | | | | | | | | | |
| Ethylhexanol | 100.0 | 0.0 | D | 1.830 | 1.710 | 1.710 | 1.710 | 1.711 | 1.711 | 1.705 |
| Butylglycol | 100.0 | 0.0 | D | 5.054 | 4.903 | 4.903 | 4.903 | 4.905 | 4.905 | 4.897 |
| Demineralized Water | 0.0 | 100.0 | D | 45.742 | 46.568 | 46.568 | 46.568 | 46.597 | 46.597 | 46.764 |

| | | | | | | | |
|---|---|---|---|---|---|---|---|
| Sum | 100 | 100 | 100 | 100 | 100 | 100 | 100 |

TABLE 3
Basecoat Compositions

| | Solvent Content | | | | | | | | | |
|---|---|---|---|---|---|---|---|---|---|---|
| | [wt.-%] | | | Amounts [parts by weight] | | | | | | |
| Ingredients | organic | H₂O | Type | E7 | E8 | E9 | E10 | E11 | E12 | E13 |
| OH-funct. Polyester 1 based on Dimeric Acid | 22.3 | 17.7 | A1 | 3.164 | 3.164 | 3.164 | 3.164 | 3.164 | 3.164 | 3.164 |
| (60 wt.-% solids) | | | | | | | | | | |
| OH-funct Polyester 2 based on Dimeric Acid | 22.3 | 17.7 | A1 | 0.570 | 0.555 | 0.564 | 0.558 | 0.543 | 0.543 | 0.544 |
| (60 wt.-% solids) | | | | | | | | | | |
| OH-funct Polyurethane 1 based on IPDI | 7.0 | 66.0 | A1 | 25.746 | 25.600 | 25.147 | 24.547 | 24.400 | 24.400 | 24.490 |
| (27 wt.-% solids) | | | | | | | | | | |
| OH-funct Polyurethane 3 based on IPDI/HMDI | 5.5 | 62.6 | A1 | 0.000 | 0.126 | 0.000 | 0.000 | 0.126 | 0.126 | 0.126 |
| (32 wt.-% solids) | | | | | | | | | | |
| OH-funct Polyurethane 4 based on TMXDI | 5.6 | 62.0 | A1 | 0.000 | 0.007 | 0.000 | 0.000 | 0.007 | 0.007 | 0.007 |
| (32.5 wt.-% solids) | | | | | | | | | | |
| OH-funct Polyacrylate Core/Shell dispersion | 13.2 | 51.8 | A1 | 4.675 | 4.681 | 4.565 | 4.455 | 4.461 | 4.461 | 4.477 |
| (35 wt.-% solids) | | | | | | | | | | |
| Low imino, highly methyl-, butyl-alkylated | 0.1 | 0.0 | A2 | 5.100 | 5.106 | 4.980 | 4.860 | 4.866 | 4.866 | 4.884 |
| melamine formaldehyde resin (99.9 wt.-% solids) | | | | | | | | | | |
| Al Effect Pigment 4, silverdollar, SiO₂ treated | 35.0 | 0.0 | B | 0.666 | 0.666 | 0.666 | 0.666 | 0.666 | 0.666 | 0.666 |
| (65 wt.-% solids) | | | | | | | | | | |
| Al Effect Pigment 5, cornflake, SiO₂ treated | 35.0 | 0.0 | B | 0.666 | 0.666 | 0.666 | 0.666 | 0.666 | 0.666 | 0.666 |
| (60 wt. % solids) | | | | | | | | | | |
| Al Effect Pigment 6, cornflake, SiO₂ treated | 40.0 | 0.0 | B | 1.332 | 1.332 | 1.332 | 1.332 | 1.332 | 1.332 | 1.332 |
| (60 wt.-% solids) | | | | | | | | | | |
| Natural Mica 2, TiO₂ coated, chrome-free treatment | 0.0 | 0.0 | C | 0.500 | 0.500 | 0.500 | 0.500 | 0.500 | 0.000 | 0.000 |
| Natural Mica 3, TiO₂ coated, with lilac | 0.0 | 0.0 | C | 0.000 | 0.000 | 0.500 | 1.000 | 1.000 | 1.500 | 2.000 |
| interference color | | | | | | | | | | |
| Glass platelets (white), TiO₂ coated, SiO₂ | 0.0 | 0.0 | E | 0.506 | 0.506 | 0.506 | 0.506 | 0.506 | 0.000 | 0.000 |
| surface treated | | | | | | | | | | |
| Colorant 2 (indanthrone, PB60) | 0.0 | 0.0 | E | 0.013 | 0.013 | 0.013 | 0.013 | 0.013 | 0.013 | 0.013 |
| Colorant 3 (carbon black, PB7) | 0.0 | 0.0 | E | 0.030 | 0.000 | 0.030 | 0.030 | 0.000 | 0.000 | 0.000 |
| Colorant 4 (perylene, PB32) | 0.0 | 0.0 | E | 0.000 | 0.037 | 0.000 | 0.000 | 0.037 | 0.037 | 0.037 |
| Rheology Control Agent 3 (layered silicate, | 0.0 | 0.0 | E | 0.740 | 0.740 | 0.722 | 0.705 | 0.706 | 0.706 | 0.708 |
| 100 wt.-% solids) | | | | | | | | | | |
| Rheology Control Agent 4 (polyacrylate, | 0.0 | 70.0 | E | 0.332 | 0.332 | 0.367 | 0.401 | 0.401 | 0.401 | 0.406 |
| 30 wt.-% solids) | | | | | | | | | | |
| Rheology Control Agent 5 (polyurethane type, | 19.0 | 40.0 | E | 0.213 | 0.213 | 0.208 | 0.203 | 0.203 | 0.203 | 0.204 |
| 41 wt.-% solids) | | | | | | | | | | |
| Dispersing Agent (aliphatic, acidic polyether, | 0.0 | 0.0 | E | 0.091 | 0.091 | 0.139 | 0.187 | 0.187 | 0.187 | 0.192 |
| 100% solids) | | | | | | | | | | |
| Polysiloxane based wetting additive 2 | 55.0 | 0.0 | E | 0.300 | 0.300 | 0.300 | 0.300 | 0.300 | 0.300 | 0.300 |
| (45 wt.-% solids) | | | | | | | | | | |
| 2,4,7,9-tetramethyl-5-decyne-4,7-diol | 48.0 | 0.0 | E | 1.568 | 1.569 | 1.670 | 1.773 | 1.774 | 1.774 | 1.792 |
| (52 wt.-% solids) | | | | | | | | | | |
| Biocide (14 wt.-% solids) | 0.0 | 86.0 | E | 0.025 | 0.025 | 0.024 | 0.023 | 0.024 | 0.024 | 0.024 |
| Matting Agent (synth. amorphous silica, | 0.0 | 0.0 | E | 0.222 | 0.222 | 0.220 | 0.217 | 0.217 | 0.217 | 0.218 |
| 100 wt.-% solids) | | | | | | | | | | |
| Dimethylethanolamine | 0.0 | 0.0 | E | 0.119 | 0.118 | 0.122 | 0.125 | 0.123 | 0.123 | 0.124 |
| Wetting/Plasticizing Agent (polypropylene glycol, | 1.0 | 0.0 | E | 0.747 | 0.742 | 0.730 | 0.713 | 0.707 | 0.707 | 0.709 |
| 99 wt. % solids) | | | | | | | | | | |
| Ethylhexanol | 100.0 | 0.0 | D | 1.700 | 1.702 | 1.660 | 1.620 | 1.622 | 1.622 | 1.628 |
| Butyldiglycol | 100.0 | 0.0 | D | 0.023 | 0.000 | 0.023 | 0.023 | 0.000 | 0.000 | 0.000 |
| Butylglycol | 100.0 | 0.0 | D | 5.936 | 5.945 | 5.881 | 5.827 | 5.836 | 5.936 | 5.945 |
| Demineralized Water | 0.0 | 100.0 | D | 45.016 | 45.043 | 45.302 | 45.587 | 45.614 | 45.614 | 45.445 |

| | | | | | | | |
|---|---|---|---|---|---|---|---|
| Sum | 100 | 100 | 100 | 100 | 100 | 100 | 100 |

TABLE 4
Clear Coat Compositions

| | Amounts [parts | |
|---|---|---|
| | by weight] | |
| | Glossy clear | Matt clear |
| Ingredients | coat | coat |
| Polyester binder | 21.80 | 19.12 |
| Polyacrylate binder mixture | 25.95 | 22.76 |
| Binder with acrylic sag control agent | 21.20 | 18.60 |
| (mixture) | | |
| Melamine resin mixture | 7.70 | 6.75 |
| Levelling additive mixture | 0.63 | 0.55 |
| Light stabilizer (HALS) | 1.00 | 0.88 |
| Light stabilizer (UV absorber) | 1.25 | 1.10 |
| Conductivity Additive | 0.02 | 0.02 |
| Aromatic solvent mixture | 5.50 | 4.83 |
| Alcohol solvent | 2.50 | 7.46 |
| Ester solvent mixture | 12.45 | 11.79 |
| Matting agent (polymer-treated thermal | — | 6.14 |
| silica) | | |
| Sum | 100.00 | 100.00 |

### Results

Table 5 shows LiDAR reflectivity of different inventive basecoat compositions E1 to E6 compared to a comparative basecoat composition C, which does not contain LiDAR reflective mica pigments (C) (the compositions are those as described in Table 2).

All inventive Examples E1 to E6 show a significant improvement in LiDAR reflectivity of the multilayer coating compared to comparative example C at the higher and relevant incident angles of 25° to 45°, particularly at 25° and 40°.

Comparing E1 and E3 shows that synthetic and natural mica have almost the same behavior in the incident angle range from 30° to 45°.

Comparing E1 with E4, and particularly E3 with E5 shows that a decrease in the amount of phthalocyanine colorants from 0.021 wt.-% to 0.011 wt.-% also leads to a further overall improvement of LiDAR reflectivity.

A comparison of E4 (1.5 wt.-% Synthetic Mica 1) and E6 (1.5 wt.-% Synthetic Mica 1 and 0.506 wt.-% glass platelets) shows that particularly in the upper range of incident angles a substitution of the Synthetic Mica 1 by using glass platelets instead, leads to less improvement of LiDAR reflectivity.

Comparing E1 with E2 shows that the presence of iron oxide beside a major amount titanium oxide in the coating of the synthetic mica leads to a decrease of LiDAR reflectivity, while there are still improvements for the 25° and 40° angle.

TABLE 5
Basecoat Compositions from Table 2 on the grey primer

| | Flop | LiDAR reflectivity [%] at different incident angles | | | | | |
|---|---|---|---|---|---|---|---|
| Example | value | 10° | 25° | 30° | 35° | 40° | 45° |
| C | 9.13 | 100.00 | 30.00 | 20.00 | 11.82 | 9.20 | 8.30 |
| E1 | 9.38 | 100.00 | 33.00 | 21.00 | 12.40 | 9.70 | 8.60 |
| E2 | 9.41 | 100.00 | 32.50 | 19.50 | 11.70 | 9.30 | 8.30 |
| E3 | 8.77 | 100.00 | 35.22 | 21.00 | 12.40 | 9.44 | 8.80 |
| E4 | 8.75 | 100.00 | 33.00 | 21.60 | 12.20 | 10.20 | 9.00 |
| E5 | 8.40 | 100.00 | 35.90 | 22.70 | 14.00 | 10.00 | 9.00 |
| E6 | 10.42 | 100.00 | 36.33 | 21.30 | 12.20 | 9.20 | 8.50 |

Table 6a below clearly shows that using tinting amounts of a LiDAR transparent perylene colorant (PB32; 0.037 wt.-%) in Example E8 instead of LiDAR absorbing carbon black (PB7; 0.030 wt.-%) in Example E7 leads to a strong improvement of LiDAR reflectivity. Thus, it is preferred to avoid using carbon black or other significantly LiDAR absorbing pigments.

The carbon black containing Examples E7, E9 and E10 differ mainly in the amount of mica pigments (C). In all three Examples 0.5 wt.-% of Natural Mica 2 is employed, However in Example E9 further 0.5 wt.-% of Natural Mica 3, and in Example E10 further 1.0 wt.-% of Natural Mica 3 are employed. The use of more mica pigments (C) in Examples E9 and E10 leads to an increased reflectivity.

TABLE 6a
Basecoat Compositions from Table 3 on the grey primer

| | Flop | LiDAR reflectivity [%] at different incident angles | | | | | |
|---|---|---|---|---|---|---|---|
| Example | value | 10° | 25° | 30° | 35° | 40° | 45° |
| E7 | 10.27 | 100.00 | 26.60 | 15.55 | 9.95 | 8.55 | 6.79 |
| E8 | 9.60 | 100.00 | 33.45 | 20.30 | 12.35 | 9.70 | 9.00 |
| E9 | 10.01 | 100.00 | 27.50 | 15.50 | 10.30 | 8.95 | 6.90 |
| E10 | 9.58 | 99.85 | 30.25 | 18.65 | 10.80 | 9.00 | 7.35 |

Table 6b shows a comparison of three different multilayer coatings E11, E12 and E13, each on a white and grey primer, the primers being composed as shown in Table 1. It was found that there is an even better reflectivity over the range of incident angles from 25° to 45° when using a white primer, rather than a grey primer. Furthermore, it was observed that an increasing amount of Natural Mica 3 from 1.5 wt.-% (E12) to 2.0 wt.-% (E13) leads to a further improvement in LiDAR reflectivity.

TABLE 6b
Basecoat Compositions from Table 3 on the grey or white primer

| | | | LiDAR reflectivity [%] at | | | | | |
|---|---|---|---|---|---|---|---|---|
| | | Flop | different incident angles | | | | | |
| Example | Primer | value | 10° | 25° | 30° | 35° | 40° | 45° |
| E11 | grey | 8.92 | 100.00 | 34.80 | 23.20 | 14.85 | 10.80 | 9.00 |
| | white | 8.65 | 100.00 | 37.25 | 23.75 | 16.80 | 11.35 | 9.55 |
| E12 | grey | 8.68 | 100.00 | 36.55 | 22.95 | 15.80 | 10.95 | 9.05 |
| | white | 8.45 | 100.00 | 37.40 | 24.05 | 17.65 | 11.50 | 9.40 |
| E13 | grey | 8.33 | 100.00 | 37.70 | 23.35 | 16.00 | 11.25 | 9.15 |
| | white | 8.07 | 100.00 | 38.80 | 26.05 | 18.05 | 12.05 | 9.75 |

In Table 7 two multilayers, both comprising the same grey primer layer and the same basecoat layer of the invention, are compared which only differ with respect to the use of a glossy clearcoat (E14) and a matt clearcoat (E15), respectively, the clearcoats being composed as shown in Table 4.

TABLE 7
Matt versus glossy clearcoat

| | | LiDAR reflectivity [%] at | | | | | |
|---|---|---|---|---|---|---|---|
| | | different incident angles | | | | | |
| Example | Clearcoat | 10° | 25° | 30° | 35° | 40° | 45° |
| E14 | glossy | 100.00 | 29.10 | 16.60 | 10.30 | 8.90 | 6.56 |
| E15 | matte | 100.00 | 39.50 | 24.10 | 13.30 | 9.90 | 8.90 |

1. A basecoat composition, comprising
(A) at least one film-forming polymer (A1), and in case of (A1) being externally crosslinkable, at least one crosslinking agent (A2);
(B) at least two types of metal effect pigments (B);
(C) at least one type of a LiDAR reflecting mica pigment (C), and
(D) water and/or one or more organic solvents as component (D).

2. The basecoat composition according to claim 1, wherein the film-forming polymer (A1) is selected from the group of polymers consisting of polyurethanes, polyureas, polyesters, polyamides, poly(meth)acrylates, and copolymers of the structural units of said polymers; and, if (A1) is externally crosslinkable, (A2) is selected from the group of crosslinking agents consisting of aminoplast resins, blocked polyisocyanates and free polyisocyanates.

3. The basecoat composition according to claim 1, wherein at least one of the metal effect pigments (B) is selected from the group consisting of cornflake-shaped aluminum pigments; and in that at least one of the metal effect pigments (B) is selected from the group consisting of silver dollar-shaped aluminum pigments.

4. The basecoat composition according to claim 1, wherein the metal effect pigments have a volume-based D90 value of less than 60 μm; a volume-based D50 value of less than 40 μm; a volume-based D10 value of less than 25 μm; and/or a platelet-thickness in a range of from 150 nm to 1000 nm.

5. The basecoat composition according to claim 1, wherein the difference between the particle size distribution span of the metal effect pigment (B) with the largest particle size distribution span and the metal effect pigment (B) with the smallest particle size distribution span is in a range of from 0.2 to 1.0, the particle size distribution span of each metal effect pigment (B) being from the volume-based D90, D50 and D10 values according to the following formula [(D90−D10)/(D50)].

6. The basecoat composition according to claim 1, wherein the total amount of metal effect pigments (B) in the basecoat composition ranges from 0.2 to 8.0 wt.-% based on the total weight of the basecoat composition.

7. The basecoat composition according to claim 1, wherein the at least one type of LiDAR reflecting mica pigment (C) is selected from the group consisting of natural mica and synthetic mica, which are uncoated or coated with one of more oxides.

8. The basecoat composition according to claim 1, wherein the main ingredient in component (D) is water.

9. The basecoat composition according to claim 1, wherein the basecoat composition further comprises one or more types of pigment (E), pigment (E) differing from pigments (B) and (C), and pigment (E) being selected from the group consisting of colored LiDAR reflecting and colored LiDAR transparent pigments.

10. The basecoat composition according to claim 1, wherein the solids content based on the total weight of the basecoat composition is in a range of from 10 to 35 wt.-%.

11. A method of forming a coating layer at least partially onto at least one surface of a substrate, wherein said method comprises at least step (a), namely
(a) applying the basecoat composition of claim 1 at least partially onto at least one surface of an optionally pre-coated substrate to form a coating film on the surface of the substrate.

12. The method of forming a coating layer according to claim 11, comprising the steps of
(a) applying the basecoat composition at least partially onto at least one surface of an optionally pre-coated substrate, to form a coating film on the substrate, wherein the coating film is a basecoat layer and the pre-coated substrate being is a filler layer coated substrate;
(b) optionally applying a clearcoat composition onto the basecoat layer to obtain a clearcoat layer; and
(c) curing the basecoat layer before applying the optional clearcoat composition or curing the basecoat layer simultaneously with the clearcoat layer,
wherein at least one of the filler layer or the clearcoat layer is present.

13. A method of improving the LiDAR reflectivity and/or LiDAR detectability of objects, the method comprising the steps of claim 11, wherein the substrate is the object or becomes part of the object, which is to be improved in view of LiDAR reflectivity and/or LiDAR detectability.

14. A coating layer obtained from the coating composition according to claim 1.

15. An at least partially coated substrate obtained by the method according to claim 11.

16. A method of using the at least partially coated substrate of claim 15, the method comprising using the at least partially coated substrate in LiDAR visibility applications concerning vehicles and parts thereof.

17. A method of improving the LiDAR reflectivity and/or LiDAR detectability of objects, the method comprising the steps of claim 12, wherein the substrate is the object or becomes part of the object, which is to be improved in view of LiDAR reflectivity and/or LiDAR detectability.

18. A coating layer obtained by the method of claim 11.

19. A coating layer obtained by the method of claim 13.

20. An at least partially coated substrate obtained by the method according to claim 13.
